(19) United States
(12) Patent Application Publication
(10) Pub. No.: US 2013/0113594 A1
(43) Pub. Date: May 9, 2013

(54) STAMP FOR MANUFACTURING CONDUCTOR LINE AND VIA AND METHOD FOR MANUFACTURING COIL PARTS

(71) Applicant: Samsung Electro-Mechanics Co., Ltd., Gyeonggi-do (KR)

(72) Inventors: Sang Moon Lee, Seoul (KR); Young Seuck Yoo, Seoul (KR); Jeong Bok Kwak, Gyeonggi-do (KR); Yong Suk Kim, Gyeonggi-do (KR); Kang Heon Hur, Gyeonggi-do (KR); Sung Kwon Wi, Seoul (KR)

(73) Assignee: SAMSUNG ELECTRO-MECHANICS CO., LTD., Gyeonggi-do (KR)

(21) Appl. No.: 13/666,863

(22) Filed: Nov. 1, 2012

(30) Foreign Application Priority Data
Nov. 4, 2011 (KR) 10-2011-0114466

(51) Int. Cl. B29C 59/00; H01F 5/00

(52) U.S. Cl. CPC B29C 59/002; H01F 5/003
USPC 336/200; 425/385; 264/104

(57) ABSTRACT

The present invention discloses a stamp for manufacturing a conductor line and a via including: an imprint body portion having a plate shape; a line imprint portion continuing in a spiral shape from an outer side to a center side of the imprint body portion while projecting from one surface of the imprint body portion; and a via imprint portion projecting from an end portion of the line imprint portion positioned on the center side of the imprint body portion while projecting from one surface of the imprint body portion, and a method for manufacturing coil parts using the same.

According to the present invention, it is possible to improve productivity of coil parts and reduce manufacturing costs by simplifying manufacturing processes of a conductor line and a via and implement a fine line width of the conductor line.

### CROSS-REFERENCE TO RELATED APPLICATIONS

Claim and incorporate by reference domestic priority application and foreign priority application as follows:

### Cross Reference to Related Application

This application claims the benefit under 35 U.S.C. Section 119 of Korean Patent Application Serial No. 10-2011-0114466, entitled filed Nov. 4, 2011, which is hereby incorporated by reference in its entirety into this application.

### BACKGROUND OF THE INVENTION

1. Field of the Invention

The present invention relates to a stamp for manufacturing a conductor line and a via and a method for manufacturing coil parts using the same, and more particularly, to a stamp for manufacturing a conductor line and a via that can improve productivity of coil parts and reduce manufacturing costs by simplifying a manufacturing process of a conductor line and implement a fine line width of the conductor line, and a method for manufacturing coil parts using the same.

2. Description of the Related Art

Electronic products, such as digital TVs, smart phones, and notebook computers, have functions for data communication in radio-frequency bands. Such IT electronic products are expected to be more widely used since they have multifunctional and complex features by connecting not only one device but also USBs and other communication ports.

Here, for higher-speed data communication, data are communicated through many internal signal lines by moving from MHz frequency bands to GHz radio-frequency bands.

When more data are communicated between a main device and a peripheral device over a GHz radio-frequency band, it is difficult to provide smooth data processing due to signal delay and other noises.

In order to solve the above problem, an EMI prevention part is provided around the connection between an IT device and a peripheral device. However, conventional EMI prevention parts are used only in limited regions such as specific portions and large-area substrates since they are coil-type and stack-type and have large chip part sizes and poor electrical characteristics. Therefore, there is a need for EMI prevention parts that are suitable for slim, miniaturized, complex, and multifunctional features of electronic products.

In case of the conventional coil-type and stack-type EMI prevention parts, there is a limitation in forming an internal circuit required for addition of various functions to a small area to correspond to formation and miniaturization of an internal conductor pattern and various problems occur.

More specifically, in the conventional coil-type and stack-type EMI prevention parts, a plurality of internal patterns, that is, coil-shaped patterns are formed in a limited area by applying a current after forming a via for formation of a fine line width of the internal conductor pattern and connection between the stacked upper and lower patterns. Thus, there are many problems such as degradation of DC bias characteristics due to an increase in variation of impedance. DC resistance, and inductance according to a high current, an increase in internal resistance due to distortion and disconnection of the patterns caused by non-uniformity of thickness between layers, and a reduction in impedance and coupling coefficient due to poor alignment of the upper and lower conductor patterns.

That is, the internal conductor pattern is formed by a photolitho process. At this time, there are various problems in deposition, exposure, developing, plating, and etching processes when forming the internal conductor pattern directly on a magnetic substrate and a polymer resin insulating layer or on the magnetic substrate.

In particular, in the etching process, when removing an unnecessary metal pattern to implement a fine line width of the internal conductor pattern, since it is difficult to permeate an etching solution and peel the pattern due to a narrow space between the adjacent patterns, there are problems such as collapse of the pattern and local removal of the actual pattern due to over-etching. Further, there is a problem of deterioration of product reliability due to deterioration of adhesion between the internal conductor pattern and a substrate caused by undercut.

That is, as shown in (a) of FIG. 1, an outer portion of the internal conductor pattern 1 is collapsed, thus causing an increase in DC resistance, a main characteristic of the EMI electronic component, and a reduction in coupling coefficient due to the poor alignment between the upper and lower internal conductor patterns.

Further, as shown in (b) of FIG. 1, separation or peeling of the substrate and the pattern occurs due to the over-etching after the etching process for forming the internal conductor pattern, thus causing the deterioration of the adhesion between the substrate and the internal conductor pattern 2 and the deterioration of the product reliability.

Further, as shown in (c) of FIG. 1, a thickness of the internal conductor pattern 3 is non-uniform, thus causing the deterioration of the adhesion with the internal conductor pattern and the distortion of the pattern due to occurrence of a step when forming a plurality of layers.

### SUMMARY OF THE INVENTION

The present invention has been invented in order to overcome the above-described problems and it is, therefore, an object of the present invention to provide a stamp for manufacturing a conductor line and a via that can improve manufacturing processability of coil parts by simplifying a manufacturing process of a coil layer which is an insulating layer having a primary coil and a secondary coil, and a method for manufacturing coil parts using the same.

It is another object of the present invention to provide a stamp for manufacturing a conductor line and a via that can improve productivity and implement cost reduction by removing defects occurred when forming a conductor pattern on a conventional ferrite substrate through a thin-film process, and a method for manufacturing coil parts using the same.

In accordance with one aspect of the present invention to achieve the object, there is provided a stamp for manufacturing a conductor line and a via including: an imprint body portion having a plate shape; a line imprint portion continuing in a spiral shape from an outer side to a center side of the imprint body portion while projecting from one surface of the imprint body portion; and a via imprint portion projecting from an end portion of the line imprint portion positioned on the center side of the imprint body portion while projecting from one surface of the imprint body portion.

A self-assembled monolayers (SAM) coating layer may be further formed on at least one surface of the imprint body portion and the surface of the line imprint portion and the via imprint portion.

The stamp for manufacturing a conductor line and a via may further include a connection terminal portion which projects with the same thickness as the line imprint portion while extending from the end portion of the line imprint portion to form a base from which the via imprint portion projects.

Meanwhile, the imprint body portion, the line imprint portion, and the via imprint portion may be integrally formed through electroforming by filling a molding material in a stamp manufacturing mold manufactured through a photolithography process.

At this time, the molding material may include nickel and polymers.

In accordance with another aspect of the present invention to achieve the object, there is provided a method for manufacturing coil parts including: providing an insulating material on a first conductor line formed on a ferrite substrate; forming a second conductor line pattern and a via hole communicated with the first conductor line at the same time by imprinting a stamp for manufacturing a conductor line and a via on the insulating material; and forming a second conductor line and a via electrically connected to the first conductor line by plating a conductive material on the second conductor line pattern and the via pattern.

Here, the insulating material may include at least one of epoxy and polymers as photoresist.

And the first conductor line and the conductive material may include copper (Cu).

The method for manufacturing coil parts may include the step of forming the first conductor line by applying photoresist on the ferrite substrate and imprinting a stamp for manufacturing a conductor line on the photoresist before providing the insulating material on the first conductor line.

The method for manufacturing coil parts may include the step of forming a first internal lead line electrically connected to the via and a second internal lead line electrically connected to the second conductor line after forming the second conductor line and the via.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view for explaining problems occurred when forming a conventional internal conductor pattern, wherein (a) is a view showing collapse of an outer pattern, (b) is a view showing separation between the pattern and a substrate, and (c) is a view showing a change in upper shape of the pattern;

FIG. 2 is a cross-sectional view and a plan view schematically showing a stamp for manufacturing a conductor line and a via in accordance with the present invention; and

FIGS. 3a to 3i are process cross-sectional views schematically showing a method for manufacturing a coil part using the stamp for manufacturing a conductor line and a via of FIG. 2.

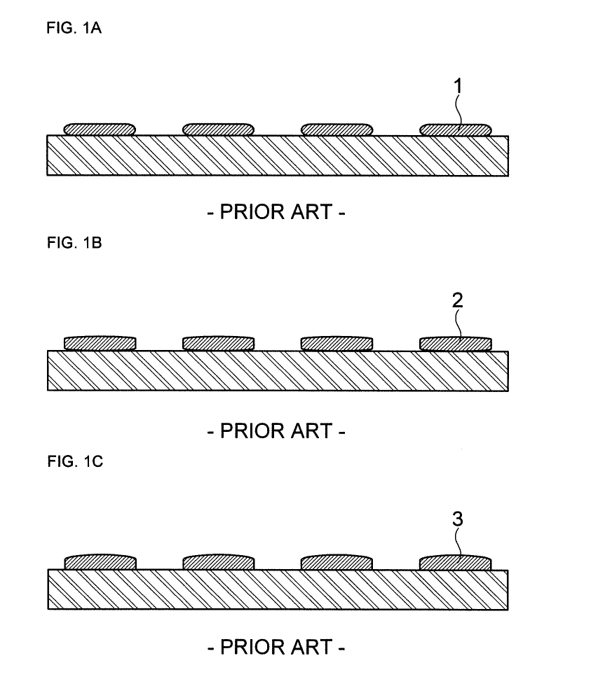

### DETAILED DESCRIPTION OF THE PREFERABLE EMBODIMENTS

Advantages and features of the present invention and methods of accomplishing the same will be apparent by referring to embodiments described below in detail in connection with the accompanying drawings. However, the present invention is not limited to the embodiments disclosed below and may be implemented in various different forms. The exemplary embodiments are provided only for completing the disclosure of the present invention and for fully representing the scope of the present invention to those skilled in the art. Like reference numerals refer to like elements throughout the specification.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

The embodiments of the present invention will be described with reference to cross-sectional views or plan views as ideal exemplary views of the present invention. In the drawings, the thicknesses or dimensions of layers and regions are exaggerated for effective description of technical features. Accordingly, shapes of the exemplary views may be modified according to manufacturing techniques and/or allowances. Therefore, the embodiments of the present invention are not limited to the specific shapes illustrated in the exemplary views, but may include other shapes that may be created according to manufacturing processes. For example, an etched region illustrated as a rectangle may have rounded or curved features. Thus, the regions illustrated in the drawings are schematic in nature, and their shapes are intended to exemplify the specific shapes of the regions of a device and are not intended to limit the scope of the present invention.

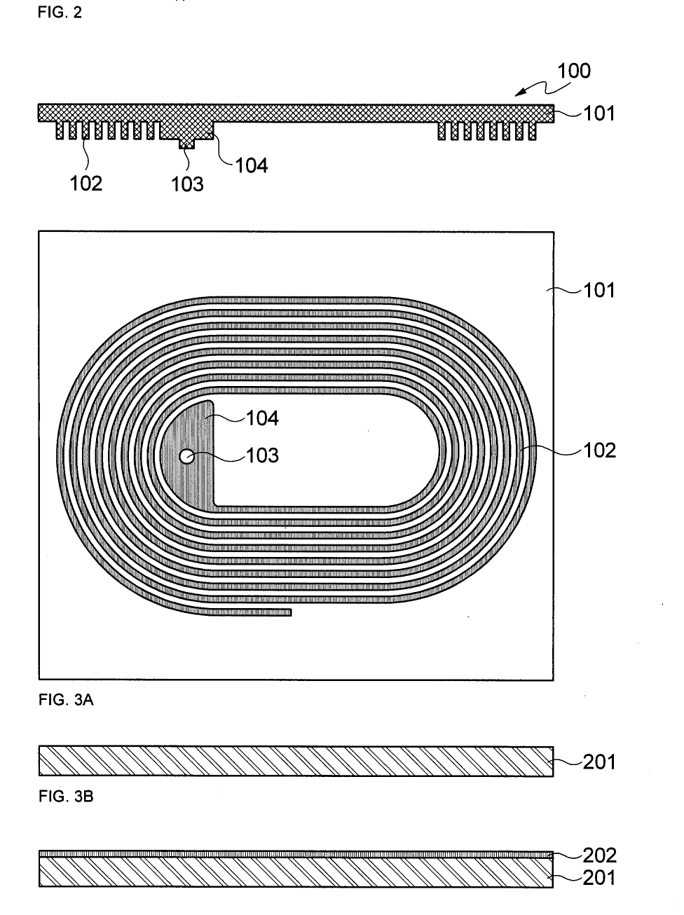

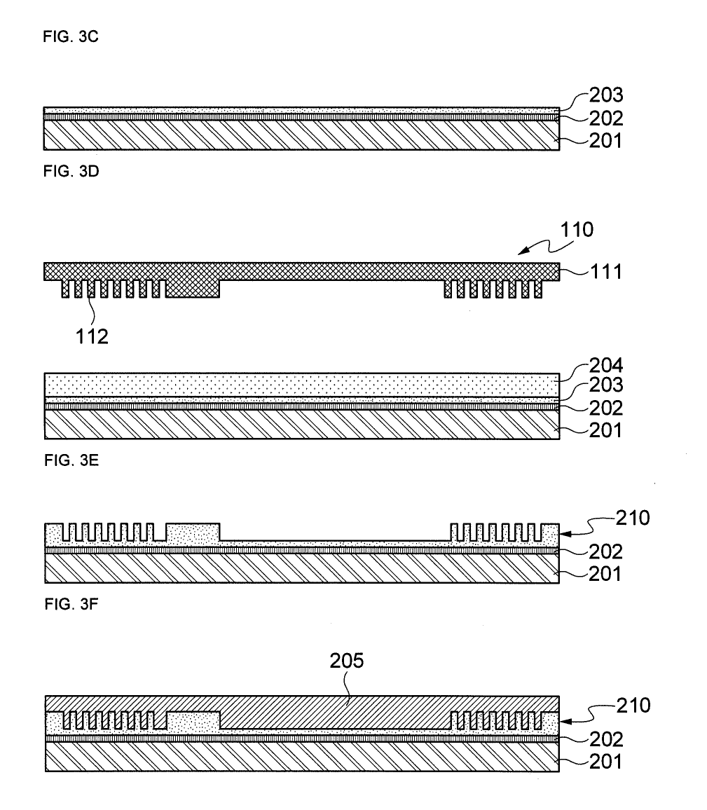

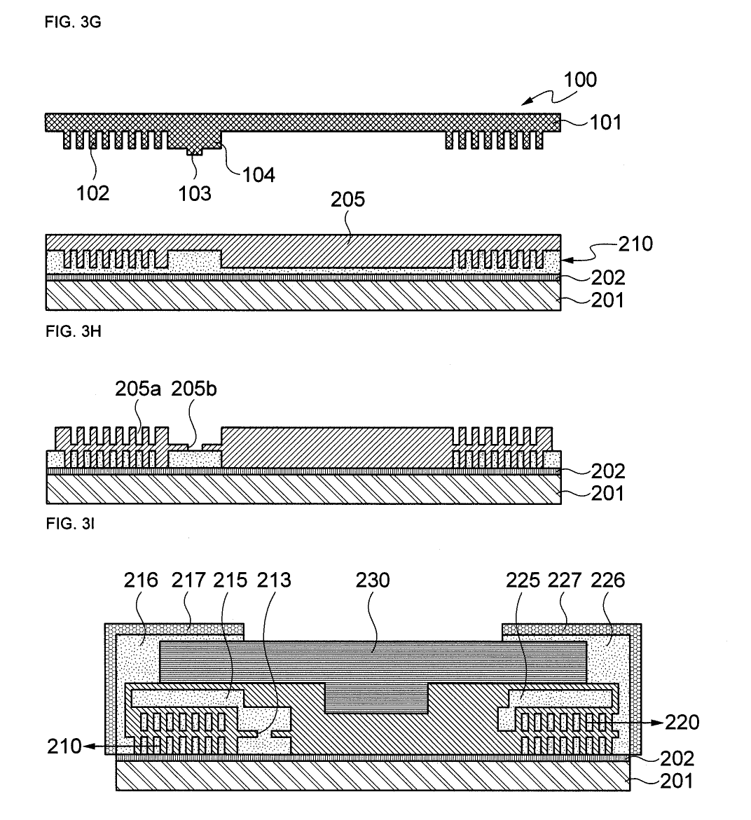

Hereinafter, embodiments of a stamp for manufacturing a conductor line and a via and a method for manufacturing a coil part using the same in accordance with the present invention will be described in detail with reference to FIGS. 2 to 3i.

FIG. 2 is a cross-sectional view and a plan view schematically showing a stamp for manufacturing a conductor line and a via in accordance with the present invention, and FIGS. 3a to 3i are process cross-sectional views schematically showing a method for manufacturing a coil part using the stamp for manufacturing a conductor line and a via of FIG. 2.

First, an embodiment of the stamp for manufacturing a conductor line and a via in accordance with the present invention will be described with reference to FIG. 2.

Referring to FIG. 2, an embodiment 100 of the stamp for manufacturing a conductor line and a via in accordance with the present invention may include an imprint body portion 101, a line imprint portion 102 projecting from one surface of the imprint body portion 101, and a via imprint portion 103 projecting from an end portion of the line imprint portion 102.

The imprint body portion 101 may have a plate shape. That is, the imprint body portion 101 forms a base which supports the entire stamp 100 for manufacturing a conductor line and a via of the present embodiment.

The line imprint portion 102 may continue in a spiral shape from an outer side to a center side of the imprint body portion 101 while projecting from one surface of the imprint body portion 101. That is, the line imprint portion 102 is a portion of imprinting a conductor pattern for forming a conductor line when manufacturing a coil part using the stamp 100 for manufacturing a conductor line and a via of the present embodiment.

The via imprint portion 103 may project from the end portion of the line imprint portion 102 positioned on the center side of the imprint body portion 101 while projecting from one surface of the imprint body portion 101. That is, the via imprint portion 103 is a portion of imprinting a via for electrically connecting between the conductor lines of layers or electrically connecting leads for drawing the conductor lines when manufacturing the coil part using the stamp 100 for manufacturing a conductor line and a via of the present embodiment.

Meanwhile, the stamp 100 for manufacturing a conductor line and a via of the present embodiment may further include a self-assembled monolayers (SAM) coating layer formed on at least one surface of the imprint body portion 101 and the surface of the line imprint portion 102 and the via imprint portion 103.

That is, the stamp 100 for manufacturing a conductor line and a via of the present embodiment can be smoothly separated after imprinting in the imprinting process by forming the SAM coating layer on the surface thereof, thereby securing high release properties.

The process of forming the SAM coating layer may use the well-known various methods. Thus, detailed description thereof will be omitted.

The stamp 100 for manufacturing a conductor line and a via of the present embodiment may further include a connection terminal portion 104 which projects with the same thickness as the line imprint portion 102 while extending from the end portion of the line imprint portion 102 to form a base from which the via imprint portion 103 projects.

Meanwhile, although not described in detail, the stamp 100 for manufacturing a conductor line and a via of the present embodiment may be integrally formed through electroforming by filling a molding material including nickel and polymers in a stamp making mold manufactured through a photolithography process.

That is, patterns corresponding to the imprint body portion 101, the line imprint portion 102, and the via imprint portion 103 may be formed on the surface of the stamp making mold through a photolithography process. The stamp 100 for manufacturing a conductor line and a via of the present embodiment in which the imprint body portion 101, the line imprint portion 102, and the via imprint portion 103 are integrally formed can be manufactured like electroforming by curing the molding material after filling the molding material on the surface of the stamp making mold.

Next, an embodiment of a method for manufacturing a coil part using the stamp 100 for manufacturing a conductor line and a via in accordance with the present invention will be described with reference to FIGS. 3a to 3i.

First, as shown in FIG. 3a, a ferrite substrate 201, which is made of ferrite, that is, a magnetic material, is prepared.

And, as shown in FIG. 3b, an insulating layer 202 is formed by applying or coating an insulating material on an upper surface of the ferrite substrate 201.

Next, as shown in FIG. 3c, a metal seed layer 203 is formed on the insulating layer 202 by sputtering and so on.

And, as shown in FIG. 3d, after a photoresist layer 204 is formed on the metal seed layer 203, a first conductor line pattern (not shown) is formed by imprinting a stamp 110 for manufacturing a conductor line on the photoresist layer 204. At this time, the metal seed layer 203 may include copper (Cu). And, the stamp 110 for manufacturing a conductor line may be manufactured by the similar method to the above-described stamp 100 for manufacturing a conductor line and a via and include an imprint body portion 111 and a line imprint portion 112 which projects from one surface of the imprint body portion 111 to correspond to the first conductor line pattern.

Next, as shown in FIG. 3e, a first conductor line 210 of a coil part is formed by plating a metal layer including copper (Cu) on the first conductor line pattern and etching the photoresist layer.

And, as shown in FIG. 3f, an insulating layer 205 is formed by applying or coating an insulating material including at least one of epoxy and polymers as photoresist on the first conductor line 210.

Next, as shown in FIG. 3g, the above-described stamp 100 for manufacturing a conductor line and a via is imprinted on the insulating material, that is, the insulating layer 205.

Then, as shown in FIG. 3h, a second conductor line pattern 205a and a via hole 205b communicated with the first conductor line 210 are formed on the insulating layer 205. At this time, since a SAM coating layer is formed on the surface of the stamp 100 for manufacturing a conductor line and a via of the present embodiment, the stamp 100 for manufacturing a conductor line and a via can be smoothly separated from the insulating layer after imprinting on the insulating layer 205.

Next, as shown in FIG. 3i, a second conductor line 220 and a via 213 electrically connected to the first conductor line 210 are formed by performing a thin-film process and so on after plating a metal layer including a conductive material such as copper (Cu) on the second conductor line pattern 205a and the via hole 205b.

After that, a first internal lead line 215 electrically connected to the via 213 and a second internal lead line 225 electrically connected to the second conductor line 220 are formed.

In addition, the first conductor line 210 may include a first external lead line 216 and a first external terminal 217 electrically connected to the first external lead line 216. At this time, the first internal lead line 215 is also electrically connected to a separate external terminal (not shown) so that the external terminals can perform functions of input and output terminals of electricity for external connection of the first conductor line 210.

Further, the second conductor line 220 may include a second external lead line 226 and a second external terminal 227 electrically connected to the second external lead line 226. At this time, the second internal lead line 225 is also electrically connected to a separate external terminal (not shown) so that the external terminals can perform functions of input and output terminals of electricity for external connection of the second conductor line 220.

Meanwhile, a magnetic layer 230 may be provided on a coil layer of the coil part including the first conductor line 210, the second conductor line 220, and the internal lead lines 215 and 225.

As described above, according to the stamp for manufacturing a conductor line and a via and the method for manufacturing a coil part using the same in accordance with the present invention, it is possible to improve manufacturing processability.

Further, according to the stamp for manufacturing a conductor line and a via and the method for manufacturing a coil part using the same in accordance with the present invention, it is possible to improve productivity and reduce manufacturing costs by preventing defects occurred when performing a thin-film process on a conventional ferrite substrate.

The foregoing description illustrates the present invention. Additionally, the foregoing description shows and explains only the preferred embodiments of the present invention, but it is to be understood that the present invention is capable of use in various other combinations, modifications, and environments and is capable of changes and modifications within the scope of the inventive concept as expressed herein, commensurate with the above teachings and/or the skill or knowledge of the related art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

What is claimed is:

1. A stamp for manufacturing a conductor line and a via, comprising:
an imprint body portion having a plate shape;
a line imprint portion continuing in a spiral shape from an outer side to a center side of the imprint body portion while projecting from one surface of the imprint body portion; and
a via imprint portion projecting from an end portion of the line imprint portion positioned on the center side of the imprint body portion while projecting from one surface of the imprint body portion.

2. The stamp for manufacturing a conductor line and a via according to claim 1, wherein a self-assembled monolayers (SAM) coating layer is further formed on at least one surface of the imprint body portion and the surface of the line imprint portion and the via imprint portion.

3. The stamp for manufacturing a conductor line and a via according to claim 1 or 2, further comprising:
a connection terminal portion which projects with the same thickness as the line imprint portion while extending from the end portion of the line imprint portion to form a base from which the via imprint portion projects.

4. The stamp for manufacturing a conductor line and a via according to claim 1, wherein the imprint body portion, the line imprint portion, and the via imprint portion are integrally formed through electroforming by filling a molding material in a stamp making mold manufactured through a photolithography process.

5. The stamp for manufacturing a conductor line and a via according to claim 4, wherein the molding material comprises nickel and polymers.

6. A method for manufacturing coil parts, comprising:
providing an insulating material on a first conductor line formed on a ferrite substrate;
forming a second conductor line pattern and a via hole communicated with the first conductor line at the same time by imprinting a stamp for manufacturing a conductor line and a via on the insulating material; and
forming a second conductor line and a via electrically connected to the first conductor line by plating a conductive material on the second conductor line pattern and the via pattern.

7. The method for manufacturing coil parts according to claim 6, wherein the insulating material comprises at least one of epoxy and polymers as photoresist.

8. The method for manufacturing coil parts according to claim 6, wherein the first conductor line and the conductive material comprise copper (Cu).

9. The method for manufacturing coil parts according to claim 6, comprising, before providing the insulating material on the first conductor line, forming the first conductor line by applying photoresist on the ferrite substrate and imprinting a stamp for manufacturing a conductor line on the photoresist.

10. The method for manufacturing coil parts according to claim 6, comprising, after forming the second conductor line and the via, forming a first internal lead line electrically connected to the via and a second internal lead line electrically connected to the second conductor line.

11. A coil part comprising:
a ferrite substrate;
a first conductor line formed by plating a conductive material on a first conductor pattern formed by an imprinting method using a stamp for manufacturing a conductor line while being provided on the ferrite substrate; and
a second conductor line and a via formed by plating a conductive material on a second conductor pattern and a via pattern formed by an imprinting method using a stamp for manufacturing a conductor line and a via while being provided to be insulated from the first conductor line.
